(19) United States
(12) Patent Application Publication
(10) Pub. No.: US 2026/0091375 A1
(43) Pub. Date: Apr. 2, 2026

(54) UNSUPPORTED ALKALI METAL-PROMOTED MOLYBDENUM CARBIDE CATALYSTS

(71) Applicant: The Government of the United States of America, as represented by the Secretary of the Navy, Arlington, VA (US)

(72) Inventors: James R. Morse, Stage College, PA (US); Cameron F. Holder, Burke, VA (US); Heather D. Willauer, Fairfax Station, VA (US); Jeffrey W. Baldwin, Fairfax Station, VA (US); Andrew R. Shabaev, Bethesda, MD (US)

(73) Assignee: The Government of the United States of America, as represented by the Secretary of the Navy, Arlington, VA (US)

(21) Appl. No.: 19/335,156

(22) Filed: Sep. 22, 2025

Related U.S. Application Data
(60) Provisional application No. 63/700,913, filed on Sep. 30, 2024.

(51) Int. Cl. B01J 27/22; B01J 37/08; B01J 37/12; C10K 3/02

(52) U.S. Cl. CPC B01J 27/22; B01J 37/08; B01J 37/12; C10K 3/026

(57) ABSTRACT

An unsupported bulk alkali-promoted molybdenum carbide (A-Mo₂C) catalyst for use in the reverse water-gas shift (RWGS) reaction, and a method of making the same, is presented. In embodiments, a method for forming an unsupported bulk molybdenum carbide (Mo₂C) catalyst promoted with an alkali earth metal includes: generating phase pure molybdenum trioxide (MoO₃) by calcining a molybdate precursor salt; producing non-passivated Mo₂C from carburization of the phase pure MoO₃; passivating the non-passivated Mo₂C to form passivated Mo₂C; and producing an active unsupported alkali metal (A) promoted Mo₂C (A-Mo₂C) catalyst from the passivated Mo₂C and an alkali metal carbonate (A-CO₃).

### CROSS-REFERENCE TO RELATED APPLICATIONS

This Application is a Nonprovisional of, and claims the benefit of priority under 35 U.S.C. § 119 based on, U.S. Provisional Patent Application No. 63/700,913 filed Sep. 30, 2024, entitled “UNSUPPORTED MOLYBDENUM CARBIDE WITH POTASSIUM DOPANTS FOR SELECTIVE HYDROGENATION OF CO₂ INTO CO.” The Provisional Application and all references cited herein are hereby incorporated by reference into the present disclosure in their entirety.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case No. 212362-US02.

### BACKGROUND OF THE INVENTION

Aspects of the present invention relate generally to catalysts for the Reverse Water Gas Shift (RWGS) reaction and, more particularly, to bulk, unsupported, alkali-promoted Mo₂C catalysts.

Carbon dioxide (CO₂) from the combustion of fossil fuels is widely considered to have a multitude of negative environmental impacts. Research efforts have focused on both capturing and utilizing CO₂, as it represents a ubiquitous feedstock for the production of value-added hydrocarbons including fuels. Numerous gas-to-liquid applications have been recently realized that result in the formation of fuels, kerosene, paraffins, solvents, and many other materials. Unfortunately, the direct conversion of CO₂ into these value-added hydrocarbons through processes such as the Fischer-Topsch (FT) reaction has remained a significant challenge due to low product yields and reduced catalyst lifetimes relative to traditional FT operations. An alternative to direct CO₂-FT would be to first reduce the CO₂ precursor to carbon monoxide (CO) through the Reverse Water Gas Shift reaction (RWGS), then generate the desired hydrocarbons in greater yields using a dedicated FT catalyst. In general, the RWGS reacts CO₂ with hydrogen gas (H₂) to produce carbon monoxide (CO) and water (H₂O).

The following endothermic RWGS reaction (EQ1) is equilibrium limited, with higher product yields favored at higher temperatures.

$${CO}_{2} ( g ) + {H}_{2} ( g ) ↔ CO ( g ) + {H}_{2} O ( g ) ΔH {∘}_{298 K} = + 41 kilojoules per mol ( kJ {mol}^{- 1} ) , wherein g = gaseous . \qquad EQ1$$

The equilibrium distribution for the RWGS reaction varies as a function of temperature and the initial molar ratio of H₂ to CO₂. Higher molar ratios coupled with higher reaction temperatures result in higher theoretical yields of CO; however, many RWGS catalysts exhibit decreased catalyst lifetimes above 500 degrees Celsius (° C.). While lower temperatures result in reduced CO₂ conversions, they generally provide longer-term catalyst stability and can be more readily integrated with the FT process. For instance, it has been proposed to utilize the heat generated during an exothermic FT process to drive the RWGS reaction. Also, the overall CO yield of the RWGS can be pushed beyond single-pass equilibrium limits by removing water from the product stream and recycling the resulting tail-gas back through the RWGS reactor. In order to maximize the yield of value-added hydrocarbon products, RWGS catalysts must ultimately exhibit high CO selectivity. This is especially challenging to achieve at the lower temperatures and pressures commonly utilized in the FT process (>15 atm and between 200-350° C.) as the methanation of CO₂ is thermodynamically favored under these conditions. Accordingly, RWGS catalysts that exhibit high CO₂ conversions and high CO selectivity at relatively low temperatures and elevated pressures are desirable.

Previous works have demonstrated that transition metal carbides, particularly molybdenum carbide and tungsten carbide, are active for the low temperature RWGS reaction. When promoted with alkali metal dopants, like sodium and potassium, these catalysts demonstrate excellent selectivity at low temperatures (300-450° C.) with CO yields approaching the thermodynamic limit even at pressures of 19.7 atm. Specifically, potassium dopants are known to alter both the physical structure and electronic properties of transition metal carbides. Together, these changes serve to improve the overall CO yield of transition metal carbides for the RWGS reaction by increasing the dispersion of surface-active sites and modifying the adsorption of reagent molecules at the catalyst surface. To date, reported protocols are limited to the synthesis of potassium molybdenum carbide (K—Mo₂C) catalysts that are supported on metal oxides.

Metal oxide supports such as γ-Al₂O₃ are commonly used in heterogeneous catalysis to improve the active surface area and/or improve the mechanical and chemical stability of catalytically active materials. However, high surface area catalysts are prone to both pressure drop and flowrate limitations which ultimately hinders the throughput and production of the catalytic reactor. Additionally, the chemical and mechanical stability of transition metal carbides, along with their inherently large surface areas, may obviate the benefits of high surface area metal oxides supports all together. Accordingly, there remains a need for effective unsupported catalysts. The term unsupported catalyst as used herein refers to a catalyst that does not rely on a support material to enhance its activity or stability.

### SUMMARY OF THE INVENTION

In a first aspect of the invention, there is a method of forming an unsupported bulk molybdenum carbide (Mo₂C) catalyst including: generating phase pure molybdenum trioxide (MoO₃) by calcining a molybdate precursor salt; producing non-passivated Mo₂C from carburization of the phase pure MoO₃; passivating the non-passivated Mo₂C to form passivated Mo₂C; and producing an active unsupported alkali metal (A) promoted Mo₂C (A-Mo₂C) catalyst from the passivated Mo₂C and an alkali metal carbonate (A-CO₃). In implementations, the molybdate precursor salt is selected from the group consisting of: ammonium molybdate tetrahydrate ((NH₄)₆Mo₇O₂₄·4H₂O), sodium molybdate (Na₂MoO₄), and molybdenum chloride (MoCl₅). In embodiments, the molybdate precursor salt is calcined at a temperature of greater or equal to 600 degrees Celsius (C) for 12 hours. In aspects of the invention, a minimum gas hourly space velocity for the carburization is greater or equal to 4.5×10³ L kg⁻¹ hr⁻¹. In implementations, the carburization occurs for at least 4 hours. Producing the non-passivated Mo₂C may comprise carburizing the phase pure MoO₃ in a flow of methane gas (CH₄) and hydrogen gas (H₂) for at least 4 hours at a temperature of greater or equal to 600° C.

In implementations, the alkali metal (A) is selected from the group consisting of: lithium (Li), sodium (Na), potassium (K), and combinations thereof. In embodiments, passivating the non-passivated Mo₂C comprises exposing the non-passivated Mo₂C to a flow of dioxygen (O₂) and nitrogen gas (N₂) for 24 hours. The flow may occur at a total gas hourly space velocity (GHSV) of at least 150 L kg⁻¹ h⁻¹. In embodiments, a quantity of the A₂CO₃ applied is proportional to a total surface area of the passivated Mo₂C and comprises between 1×10⁵ mols A per square meter (mol A m⁻²) and 2.5×10⁶ mol A m⁻² In implementations, producing the A-Mo₂C catalyst comprises heating a mixture of the passivated Mo₂C and an aqueous solution of the alkali metal carbonate (A₂CO₃) at a temperature of 80° C. until evaporation occurs. Aspects of the invention further include drying the unsupported A-Mo₂C catalyst to produce a bulk dry powder of the unsupported A-Mo₂C catalyst. In embodiments, the unsupported A-Mo₂C catalyst is selected from the group consisting of: lithium-promoted molybdenum carbide (Li—Mo₂C), sodium-promoted molybdenum carbide (Na—Mo₂C), and potassium-promoted molybdenum carbide (K—Mo₂C). In some implementations, the molar ratio of the alkali metal (A) to molybdenum (Mo) content in the unsupported A-Mo₂C catalyst is between 1:2 and 1:8. In some implementations, the molar ratio of the alkali metal (A) to molybdenum (Mo) content in the A-Mo₂C catalyst is 1:4.

In another aspect of the invention, there is an active, low temperature Reverse Water-Gas Shift (RWGS) catalyst comprising an unsupported alkali metal (A) promoted molybdenum carbide (A-Mo₂C) material. In embodiments, the alkali metal (A) is selected from the group consisting of: lithium (Li), sodium (Na), potassium (K), and combinations thereof. In implementations, a molar ratio of the alkali metal (A) to molybdenum (Mo) content in the A-Mo₂C catalyst is between 1:2 and 1:8. In embodiments, the RWGS catalyst achieves a CO yield and CO₂ conversion of 38.6% or greater during RWGS at weight hourly space velocities of 3.6×10⁵ L kg⁻¹ hr⁻¹ or greater at a temperature of 450° C. In implementations, the RWGS catalyst achieves a CO yield of 13.5% or greater and a CO₂ conversion of 13.7% or greater at weight hourly space velocities of 18×10⁴ L kg⁻¹ hr⁻¹ or greater at a temperature of 300° C.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 is a flowchart of an exemplary process for generating alkali metal promoted Mo₂C in the absence of a catalytic support for use in the RWGS reaction, in accordance with embodiments of the invention.

FIG. 2 is a plot of X-ray diffraction (XRD) patterns for products at various stages of the synthesis process of FIG. 1, in accordance with embodiments of the invention.

FIG. 3 depicts a reactor system 300 utilized to evaluate a variety of unsupported catalysts for use in a low temperature RWGS reaction.

FIG. 4 shows a plot of experimental CO₂ conversions and CO yield versus weight hourly space velocity (WHSV) (L kg⁻¹ h⁻¹) for unsupported and supported catalysts at 300° C.

FIG. 5A shows a plot 500A of CO₂ conversion and CO yield for both unsupported and supported catalysts as a function of the reagent flowrate at a reactor temperature of 450° C.

FIG. 5B shows a plot 500B of CO₂ conversions and CO yield as a function of weight hourly space velocity (WHSV) for various loadings of potassium on bulk, unsupported Mo₂C catalysts at 450° C.

### DETAILED DESCRIPTION

Aspects of the present invention relate generally to catalysts for the Reverse Water Gas Shift (RWGS) reaction and, more particularly, to bulk, unsupported, alkali-promoted Mo₂C catalysts.

Embodiments of the invention provide a new process for generating alkali (A) promoted molybdenum carbide (Mo₂C) in the absence of a catalytic support, for use as a catalyst in the RWGS reaction. In implementations, the alkali metal is selected from lithium (Li), Sodium (Na) and potassium (K). Unsupported Mo₂C catalysts of the present invention include alkali metal dopants for selective hydrogenation of carbon dioxide (CO₂) into carbon monoxide (CO). In aspects of the invention, Mo₂C is synthesized before the alkali metal is incorporated.

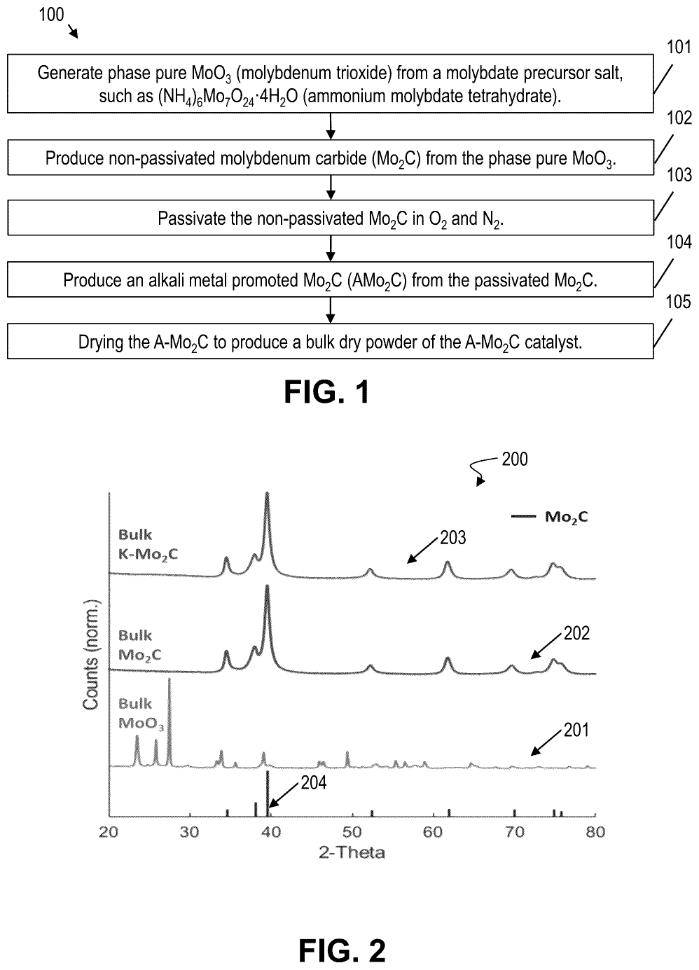

FIG. 1 is a flowchart 100 of an exemplary process for generating alkali metal promoted Mo₂C in the absence of a catalytic support for use in the RWGS reaction, in accordance with embodiments of the invention.

At 101, phase pure MoO₃ (molybdenum trioxide) is generated from a molybdate precursor salt, such as (NH₄)₆Mo₇O₂₄·4H₂O (ammonium molybdate tetrahydrate), Na₂MoO₄ (sodium molybdate), or MoCl₅ (molybdenum chloride). In implementations, (NH₄)₆Mo₇O₂₄·4H₂O is calcined in a controlled and isolated oven environment (e.g., in a muffle furnace) at a temperature of 600° C. for 12 hours to generate phase pure MoO₃ (molybdenum trioxide).

At 102, non-passivated molybdenum carbide (Mo₂C) is produced from MoO₃. In implementations, the MoO₃ generated at step 101 is carburized in a flowing gas blend of 20% CH₄ (methane) with a H₂ (hydrogen) balance for 4 hours at a temperature of 600° C., using a weight hourly space velocity of 4.5×10³ liters per kilogram per hour (L kg⁻¹ h⁻¹), then cooled to room temperature under the same flowing gas blend to generate the non-passivated Mo₂C. In implementations, higher flowrates or longer carburization times may be applied without detriment to the resulting catalyst.

At 103, the non-passivated Mo₂C is passivated using a blend of oxygen (O₂) and nitrogen (N₂). In implementations, following carburization and before introduction to ambient atmosphere, the non-passivated MO₂C material produced at step 102 is passivated at room temperature using a flowing blend of 1% O₂ (dioxygen) with a N₂ (nitrogen gas) balance for 24 hours at a total gas hourly space velocity (GHSV) of 150 L kg⁻¹ h⁻¹. The resulting passivated bulk Mo₂C is air stable and is phase pure as confirmed by powder X-ray diffraction (XRD). See the discussion of FIG. 2 below. The term bulk when applied to a catalyst herein, refers to a catalyst where the catalytically active substance makes up the entire material-meaning there isn't a separate support material.

At 104, an alkali metal promoted MO₂C catalyst product (A-Mo₂C) is produced from the passivated Mo₂C. In implementations, the passivated (and unsupported) Mo₂C is added to a solution of A₂CO₃ (where A is an alkali metal) in deionized water. The quantity of A₂CO₃ applied must be proportional to the total surface area of the unsupported Mo₂C, and may be up to 1×10⁵ mols of potassium (K) per square meter ([mols K] m⁻²) but no less than 2.5×10⁶ [mols K] m⁻². The solution mixture of MO₂C and A₂CO₃ is then stirred at 80° C. until complete evaporation occurs.

At 105, the resulting alkali promoted molybdenum carbide (A-Mo₂C) powder from step 104 is dried, thereby producing a bulk dry powder of unsupported A-Mo₂C. In implementations, the A-Mo₂C powder is dried in a muffle furnace at 120° C. for 8 hours to produce the dry unsupported A-Mo₂C. In implementations, the product is Li—Mo₂C, Na—Mo₂C, or K—Mo₂C.

### Experimental Results

FIG. 2 is a plot 200 of X-ray diffraction (XRD) patterns for products at various stages of the synthesis process of FIG. 1. FIG. 2 shows a plot of X-ray intensity as a function of the diffraction angle (2-theta). The process is shown going from bottom to top, starting at MoO₃ at 201, through Mo₂C at 202, and ending with alkali metal promoted Mo₂C (K—Mo₂C) at 203. An Mo₂C reference pattern is also depicted at 204. Characterization by X-ray diffraction indicates the synthesized Mo₂C at 202 matches the Mo₂C reference pattern at 204, indicating a phase pure material. Additionally, there is no change to the crystal phase of the resulting K—Mo₂C at 203 as compared to the Mo₂C at 202.

The specific surface areas obtained through nitrogen physisorption and Brunauer-Emmett-Teller (BET) analysis for all of the initial combinations of Mo, K, and γ-Al₂O₃ are tabulated in Table 1 below. In general, BET analysis is a technique used to measure the specific surface area of materials, primarily by studying gas adsorption. BET is commonly performed using nitrogen physisorption, which is a technique used to characterize the surface area and porosity of materials by measuring the amount of nitrogen gas adsorbed onto a material's surface at a specific temperature, typically 77 K.

The RWGS activity for various catalysts was tested at 300° C., 19.7 atm, 3:1 H₂ to CO₂ feed stream, and at a GHSV of 3.6×10³ L kg⁻¹ h⁻¹. The measured activity, selectivity, and overall CO yield for the RWGS reactions are also included in Table 1. The RWGS reaction is thermodynamically limited and therefore, the maximum theoretical CO yield under the conditions tested in Table 1 is 23%.

TABLE 1
The Mo phase after carburization as analyzed by X-ray diffraction, surface area determined
by BET, and the RWGS activity for various catalysts tested at 300° C., 19.7 bar and a 3:1
molar ratio of H₂ to CO₂. Various GHSV's are reported for the supported and unsupported
catalysts. For all catalysts, the Mo starting material in the first column is (NH₄)₆Mo₇O₂₄•4H₂O.

| | | | | CO₂ | CO | CO |
|---|---|---|---|---|---|---|
| | Mo Phase | | | Conv. | Sel. | Yield |
| Starting Material | Following | BET Surface | GHSV | (%) | (%) | (%) |
| (Molar Ratios) | Carburization | Area (m² g⁻¹) | (L kg⁻¹h⁻¹) | 300° C., 3:1 H₂:CO₂ | | |
| Prior Lit. Method | Metallic Mo | 1.0 | 3.6 × 10³ | 0.0 | N.A | N.A. |
| Bulk K—Mo (1/4)^{10, 15} | | | | | | |
| Bulk Mo | Mo₂C | 13.7 | 3.6 × 10³ | 32.6 | 8.2 | 2.7 |
| Current Invention | Mo₂C | 10.9 | 3.6 × 10³ | 20.5 | 46.3 | 9.5 |
| Bulk K—Mo (1/4) | | | | | | |
| Current Invention | Mo₂C | 10.9 | 9.0 × 10³ | 20.9 | 75.0 | 15.7 |
| Bulk K—Mo (1/4) | | | | | | |
| Current Invention | Mo₂C | 10.9 | 1.8 × 10⁴ | 19.9 | 86.3 | 17.2 |
| Bulk K—Mo (1/4) | | | | | | |
| Current Invention | Mo₂C | 10.9 | 4.5 × 10⁴ | 19.0 | 93.4 | 17.7 |
| Bulk K—Mo (1/4) | | | | | | |
| Current Invention | Mo₂C | 10.9 | 9.0 × 10⁴ | 16.6 | 97.4 | 16.2 |
| Bulk K—Mo (1/4) | | | | | | |
| Current Invention | Mo₂C | 10.9 | 1.8 × 10⁵ | 13.8 | 98.0 | 13.5 |
| Bulk K—Mo (1/4) | | | | | | |
| K—Mo@γ-Al₂O₃ | Mo₂C | 142 | 3.6 × 10³ | 20.6 | 90.6 | 18.7 |
| (1/4/15) | | | | | | |
| K—Mo@γ-Al₂O₃ | Mo₂C | 142 | 1.8 × 10⁴ | 14.1 | 97.2 | 13.7 |
| (1/4/15) | | | | | | |
| K—Mo@γ-Al₂O₃ | Mo₂C | 142 | 6.6 × 10⁴ | 2.1 | 95.7 | 2.0 |
| (1/4/15) | | | | | | |
| K—Mo@γ-Al₂O₃ | Mo₂C | 142 | 1.3 × 10⁵ | 1.2 | 99.2 | 1.2 |
| (1/4/15) | | | | | | |
| Mo@γ-Al₂O₃ (4/15) | Mo₂C | 154 | 3.6 × 10³ | 18.7 | 73.1 | 13.7 |

With reference to Table 1, the potassium (K) promoter clearly improved the performance of the Mo₂C for the RWGS reaction when supported on the γ-Al₂O₃, with both the CO₂ conversion and CO selectivity measured to be higher than for the unpromoted Mo₂C/γ-Al₂O₃ catalyst. In the absence of γ-Al₂O₃ and K promoters, the unsupported Mo₂C possessed a surface area of 13.7 m² g⁻¹ and exhibited the highest CO₂ conversions described in Table 1. However, the products of CO₂ hydrogenation were dominated by complete hydrogenation to CH₄, with CO making up only 8.2% of the total products detected. The inherently high activity of the unsupported Mo₂C suggests that it may serve as an effective RWGS catalyst, if CO formation can be selectively promoted using dopants such as K or other alkali metals. When an alkali metal is co-deposited with the molybdenum precursor in the absence of γ-Al₂O₃ and prior to calcination to obtain MoO₃, metallic molybdenum results. The resulting metallic Mo is completely unreactive for CO₂ hydrogenation under the conditions tested.

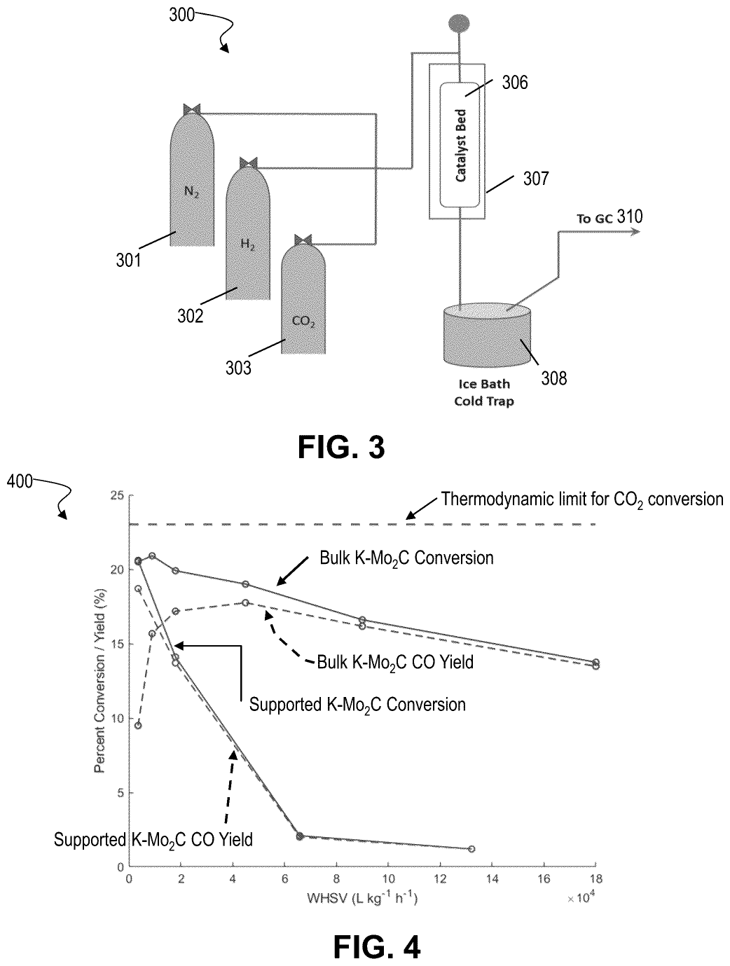

FIG. 3 depicts a reactor system 300 utilized to evaluate a variety of unsupported catalysts for use in a low temperature RWGS reaction. The system 300 includes N₂, H₂ and CO₂ gas sources 301-303, which feed gas to an enclosed catalyst bed 306. An ice bath cold trap 308 is placed downstream of the catalyst bed 306 and is configured to remove water from gas generated within the catalyst bed 306 before the gas is sent to a gas chromatograph (GC) detector at 310 for analysis.

Selective hydrogenation of CO₂ to CO through the RWGS reaction was performed using the reactor system 300 of FIG. 3. Catalyst materials were pelletized under a force of 2 tons for a total of 10 minutes and then passed through a sieve to obtain catalyst grains between 200 and 350 microns (μm) in diameter. The catalyst materials were then mixed with silicon carbide (SIC), an inert material for the low temperature RWGS, to a total mass of 500 milligrams (mg) before being loaded into a ¼″ diameter stainless steel reactor 307 (housing catalyst bed 306). The ratio of K—Mo₂C to SiC was varied in order to test a wide range of GHSVs at similar reagent flow rates. Upon loading the reactor, the catalyst bed was pretreated at 300° C. with H₂ gas at a pressure of 19.7 atmospheres (atm) and a GHSV of 6×10³ L kg⁻¹ h⁻¹ for 2.5 hours. The catalyst bed was then exposed to a flowing blend of H₂ to CO₂ at a 3:1 molar ratio. The flowing blend also contained a small flowrate of N₂ (16% by volume) which was used as an internal standard for in-line gas chromatography (GC) analysis. The total pressure in the reactor under experimental conditions was 19.7 atm while the reactor temperature was varied between 30° and 450° C. In all experiments, the reactors were allowed to equilibrate for 4 hours to achieve steady-state conversions, verified by GC analysis, before the concentration of reactant and product gasses were recorded.

FIG. 4 shows a plot 400 of experimental CO₂ conversions and CO yield versus weight hourly space velocity (WHSV) (L kg⁻¹ h⁻¹) for unsupported and supported catalysts at 300° C. . . . FIG. 4 plots the CO₂ conversion and CO selectivity for both the unsupported bulk K—Mo₂C and the supported K—Mo₂C/Al₂O₃ catalysts as a function of reagent flow rate at 300° C. and 19.7 atm. A dashed line is shown representing the thermodynamic limit for CO₂ conversion, which is 23% at 300° C. The data in FIG. 4 is tabulated in Table 1, above.

The total CO₂ conversion was higher for the unsupported K—Mo₂C sample under all conditions tested. At GHSVs of 9×10³ L kg⁻¹ h⁻¹ or less, greater CO yields were obtained for the K—Mo₂C/γ-Al₂O₃ sample, as the majority of CO₂ hydrogenation products for the unsupported catalyst consisted of undesirable CH₄. However, as the reagent flowrate was increased above 9×10³ L kg⁻¹ h⁻¹, the unsupported K—Mo₂C catalyst significantly outperforms the supported K—Mo₂C/γ-Al₂O₃ catalyst. For instance, the unsupported catalyst is shown to have a CO yield of 16.2% at a GHSV of 9.0×10⁴ L kg⁻¹ h⁻¹ whereas the supported catalyst, at a lower GHSV of 6.6×10⁴ L kg⁻¹ h⁻¹, had a CO yield of just 2.0%. This is likely due to the lower overall surface area and microporosity of the unsupported K—Mo₂C which reduces the overall impact of mass transfer limitations, allowing the catalyst to operate at steady state conditions under much higher reagent flow rates.

TABLE 2
Catalyst surface area calculated by BET analysis and RWGS activity
at select space velocities for a variety of bulk Mo₂C catalysts
that are promoted by varying amounts of potassium. The reaction conditions
were 450° C. and a 3:1 ratio of H₂ to CO₂.

| Starting | BET | | CO₂ | CO | CO |
|---|---|---|---|---|---|
| Material | Surface | GHSV | Conv. | Sel. | Yield |
| (Molar | Area | (L kg⁻¹ | (%) | (%) | (%) |
| Ratios) | (m² g⁻¹) | h⁻¹) | 450° C., 3:1 H₂:CO₂ | | |
| K—Mo@γ- | 142 | 1.3 × 10⁵ | 26.2 | 99.9 | 26.1 |
| Al₂O₃ (1/4/15) | | | | | |
| Bulk K—Mo | 10.9 | 1.8 × 10⁵ | 41.3 | 91.5 | 37.8 |
| (1/4) | | | | | |
| Bulk K—Mo | 11.2 | 1.8 × 10⁵ | 37.1 | 83 | 30.8 |
| (1/8) | | | | | |
| Bulk K—Mo | 10.5 | 1.8 × 10⁵ | 35.9 | 98.2 | 35.3 |
| (1/2) | | | | | |

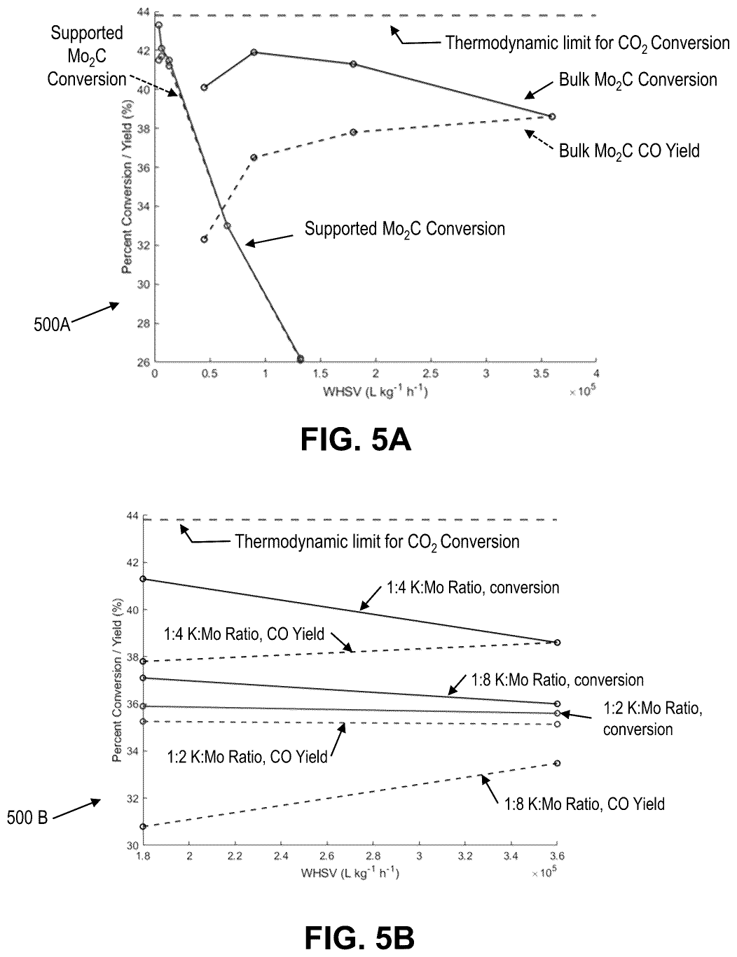

FIG. 5A shows a plot 500A of CO₂ conversion and CO yield for both unsupported and supported catalysts as a function of the reagent flowrate at a reactor temperature of 450° C. FIG. 5A is presented in order to better demonstrate the temperature range of catalyst performance, as well as the excellent reactor throughput. At the elevated temperature of 450° C., the differences in the reactor throughput are pronounced, with the unsupported K-MO₂C catalyst achieving CO yields of 38.6% at a total GHSV of 3.6×10⁵ L kg⁻¹ h⁻¹, roughly 88% of the thermodynamic limit under these conditions. For reference, under the same temperatures and pressures, the supported K—Mo₂C/γ-Al₂O₃ catalyst achieves a CO selectivity of only 33% at a reduced GHSV of 6.6×10⁴.

FIG. 5B shows a plot 500B of CO₂ conversions and CO yield as a function of weight hourly space velocity (WHSV) for various loadings of potassium (K) on bulk unsupported Mo₂C catalysts at 450° C. To determine the influence of the alkali promoter, Mo₂C catalysts were prepared with varying loadings of K. FIG. 5B plots the CO₂ conversions and CO selectivity at 450° C. and 19.7 atm for three unsupported K—Mo₂C catalyst with various K loadings of 2.5×10⁻⁶, 5.0×10⁻⁶, and 1.0×10⁻⁵ mol K m⁻². These are labelled by their respective molar ratios relative to Mo: 1:8, 1:4, and 1:2, respectively. Catalyst performance is clearly optimal at K to Mo ratios of 1:4, as this loading provided the greatest CO₂ conversion and highest CO selectivity. Additionally, this catalyst exhibited a CO selectivity of 100% at high GHSV's. For the catalysts with the 1:8 K to Mo ratio, the CO₂ conversion was significantly less when compared to the catalyst with 1:4 ratio. Additionally, the CO selectivity was also reduced, showing 83% and 93% at space velocities of 1.8×10⁵ and 3.6×10⁵ L kg⁻¹ h⁻¹, respectively. Finally, the catalyst that was loaded with twice the amount of K showed little difference between the observed CO₂ and CO selectivity as a function of GHSV, with CO₂ conversions of ˜36% and a CO selectivity of 98%. The thermodynamic limit for CO₂ conversion, which is 43.8% at 450° C. is also depicted.

Based on the above, embodiments of the invention provide a new method of preparing alkali metal promoted metal carbide catalysts without the need for metal oxide supports for the low temperature reverse water gas shift reaction. These catalysts maintain the high activity observed for supported carbide catalysts; however, the unsupported catalysts described herein show improved activity at high GHSVs when compared to existing supported catalysts.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the embodiments described. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of forming an unsupported bulk molybdenum carbide (Mo₂C) catalyst promoted with an alkali earth metal, the method comprising:
generating phase pure molybdenum trioxide (MoO₃) by calcining a molybdate precursor salt;
producing non-passivated Mo₂C from carburization of the phase pure MoO₃;
passivating the non-passivated Mo₂C to form passivated Mo₂C; and
producing an active unsupported alkali metal (A) promoted Mo₂C (A-Mo₂C) catalyst from the passivated Mo₂C and an alkali metal carbonate (A-CO₃).

2. The method of claim 1, wherein the molybdate precursor salt is selected from the group consisting of: ammonium molybdate tetrahydrate ((NH₄)₆Mo₇O₂₄·4H₂O), sodium molybdate (Na₂MoO₄), and molybdenum chloride (MoCl₅).

3. The method of claim 1, wherein the molybdate precursor salt is calcined at a temperature of greater or equal to 600° C. for 12 hours.

4. The method of claim 1, wherein a minimum gas hourly space velocity for the carburization is greater or equal to 4.5×10³ L kg⁻¹ hr⁻¹.

5. The method of claim 1, wherein the carburization occurs for at least 4 hours.

6. The method of claim 1, wherein producing the non-passivated Mo₂C comprises carburizing the phase pure MoO₃ in a flow of methane gas (CH₄) and hydrogen gas (H₂) for at least 4 hours at a temperature of greater or equal to 600° C.

7. The method of claim 1, wherein the alkali metal (A) is selected from the group consisting of: lithium (Li), sodium (Na), potassium (K), and combinations thereof.

8. The method of claim 1, wherein the passivating the non-passivated Mo₂C comprises exposing the non-passivated Mo₂C to a flow of dioxygen (O₂) and nitrogen gas (N₂) for 24 hours.

9. The method of claim 8, wherein the flow occurs at a total gas hourly space velocity (GHSV) of at least 150 L kg⁻¹ h⁻¹.

10. The method of claim 1, wherein a quantity of the A₂CO₃ applied is proportional to a total surface area of the passivated Mo₂C and comprises between 1×10⁵ mols A per square meter (mol A m⁻²) and 2.5×10⁶ mol A m⁻².

11. The method of claim 1, wherein producing the A-Mo₂C catalyst comprises heating a mixture of the passivated Mo₂C and an aqueous solution of the alkali metal carbonate (A₂CO₃) at a temperature of 80° C. until evaporation occurs.

12. The method of claim 1, further comprising drying the unsupported A-Mo₂C catalyst to produce a bulk dry powder of the unsupported A-Mo₂C catalyst.

13. The method of claim 1, wherein the unsupported A-Mo₂C catalyst is selected from the group consisting of: lithium-promoted molybdenum carbide (Li—Mo₂C), sodium-promoted molybdenum carbide (Na—Mo₂C), and potassium-promoted molybdenum carbide (K—Mo₂C).

14. The method of claim 1, wherein a molar ratio of the alkali metal (A) to molybdenum (Mo) content in the unsupported A-Mo₂C catalyst is between 1:2 and 1:8.

15. The method of claim 14, wherein the molar ratio of the alkali metal (A) to molybdenum (Mo) content in the A-Mo₂C catalyst is 1:4.

16. An active, low temperature Reverse Water-Gas Shift (RWGS) catalyst comprising an unsupported alkali metal (A) promoted molybdenum carbide (A-Mo₂C) material.

17. The active RWGS catalyst of claim 16, wherein the alkali metal (A) is selected from the group consisting of: lithium (Li), sodium (Na), potassium (K), and combinations thereof.

18. The active RWGS catalyst of claim 16, wherein a molar ratio of the alkali metal (A) to molybdenum (Mo) content in the A-Mo₂C catalyst is between 1:2 and 1:8.

19. The active RWGS catalyst of claim 16, wherein the RWGS catalyst achieves a CO yield and CO₂ conversion of 38.6% or greater during RWGS at weight hourly space velocities of 3.6×10⁵ L kg⁻¹ hr⁻¹ or greater at a temperature of 450° C.

20. The active RWGS catalyst of claim 16, wherein the RWGS catalyst achieves a CO yield of 13.5% or greater and a CO₂ conversion of 13.7% or greater at weight hourly space velocities of 18×10⁴ L kg⁻¹ hr⁻¹ or greater at a temperature of 300° C.
